(19) United States
(12) Patent Application Publication
(10) Pub. No.: US 2005/0021393 A1
(43) Pub. Date: Jan. 27, 2005

(54) Smart interactive billboard device

(76) Inventors: Xiaoming Bao, Singapore (SG); Ranganatha Sitaram, Singapore (SG); Ramanath Padmanabhan, Singapore (SG)

Correspondence Address: GREENBLUM & BERNSTEIN, P.L.C., 1950 ROLAND CLARKE PLACE, RESTON, VA, 20191, US

(21) Appl. No.: 10/479,968

(22) PCT Filed: Jun. 12, 2001
(86) PCT No.: PCT/SG01/00115

(51) Int. Cl. G06F 17/60

(52) U.S. Cl. 705/14

(57) ABSTRACT

A smart interactive billboard for allowing or other devices implemented with the smart billboard to display electronic/computer-based information and become interactive includes a transceiver adapted to communicate interactively with a server and at least one or more client devices to allow users to be interactive with the implemented billboards or other devices. A CPU including software controls the implemented billboards or other devices. A memory stores information received or uploaded to the implemented billboards or other devices from the server and client devices, and a display unit displays the information on the implemented billboards or other devices.

### BACKGROUND OF THE INVENTION

1 Field of the Invention

The present invention relates to a smart interactive billboard device that allows billboards or other devices, implemented with the smart billboard device, to display electronic/computer-based information and become interactive. More particularly, the present invention relates to a smart interactive billboard device that allows users to remotely upload information to, download information from, and perform electronic commerce transactions with the billboards, implemented with the smart billboard device.

2. Description of the Related Art

Billboard advertising is a popular means for marketing a retailer's products since they are large, appealing and attractive. Products can include services, goods or the like. Generally, billboards are two-dimensional, is however, billboards can be three-dimensional.

Advertisements that are posted on two-dimensional, static billboards can capture the attention of potential customers because of their size. The information provided on the billboards, however, is limited and their content is not readily changed. Moreover, they provide little or no opportunity for a customer to follow up when interested. For example, when a customer is driving pass the billboard, the customer may not be able to safely write down the information from the billboard while driving.

Three-dimensional billboards can be more attractive than two-dimensional billboards since they usually contain animation or the like, and are visible in the daytime and nighttime. Also, the display may be changeable in short periods of time, thereby preventing a passing viewer from noting all relevant information. Similar to the two-dimensional billboards, the information provided on the three-dimensional billboards may be limited.

Further, the information or advertisements provided on the conventional two- and three-dimensional billboards are difficult to update and maintain, as they require on-site attention. In addition, both types of billboards are non-interactive, i.e., the billboards do not support purchases or other electronic commerce transactions.

Web-based and cell-phone based advertising is another popular marketing tool for retailers. The web-based and cell-phone based advertisements are capable of automatically updating according to a user's demographics, requirements and behavior. Further, the user can selectively choose or filter information from the advertisement, and perform electronic commerce transactions with respect to the displayed advertisement. However, there are restrictions depending on the user's device, i.e., wireless device such as a pager, mobile or cell phone or the like.

U.S. Pat. No. 6,219,696 issued on Apr. 17, 2001 to Wynblatt et al., concerns a system for providing targeted Internet information to mobile devices is The system provides for the just-in-time distribution of information through mobile information terminals. The system involves the Internet as the primary source of information, and includes a mobile information terminal as the output device and a local agent that is locally operated. The mobile information terminal includes a receiver, a URL queue and a www renderer/browser. The local agent includes a short-range transmitter for distributing information pointers to mobile information terminals and a mechanism for transferring data into the transmitter.

WO 00/62564 (Blow), System and Method for Distributing Advertising and Gathering Information in a Wireless Communication Network, published on Oct. 19, 2000, relates to a system and method for inserting and distributing commercial advertising to wireless phone subscribers A subscriber enters a user profile either when initially signing up for service or through an interactive menu on the phone handset. Through phone registration messages transmitted as overhead messages within the wireless network, the network determines the location of the phone. The system subsequently transmits advertising messages to the user at call origination based upon the user profile and cell location. The system uses the subscriber location to transmit messages to the user phone that will launch a browser like application within the phone. The browser displays textual or graphical advertisements on the handset display. In addition, the system initiates browser pop-up polling queries in which the user offers responses. The phone uses packetized data transmission to transmit the responses bark to the base station. The system accumulates and processes the various user responses, and uses location information to selectively transmit electronic coupon offers to local subscribers. There is a need for a smart interactive billboard device that may be on a fixed or mobile platform, and that allows billboards or other devices, implemented with the smart billboard device, to capture the attention of potential customers by displaying on the billboards electronic/computer-based information or advertisements. There is also a need for a compact, smart billboard device that allows users to become interactive with the billboards. i.e., download information to, upload information from, and perform electronic commerce transactions with respect to the, information displayed on the billboards.

### SUMMARY OF THE INVENTION

Accordingly, it is an object of the present invention to overcome the disadvantages of the prior art, and to provide a smart interactive billboard device that can be installed on stationary and mobile platforms.

It is another object of the present invention to provide a smart interactive billboard device that allows users or customers with client devices to download information from and upload information to billboards or other devices implemented with the smart billboard device.

It is still a further object of the present invention to provide a smart interactive device that allows users or customers to perform electronic commerce transactions with respect to the information displayed on the billboards or other devices implemented with the smart billboard device.

It is yet a further object of the present invention to provide a smart interactive device that allows: users or customers to exchange or transfer information amongst other users or customers using the billboards or other devices implemented with the smart billboard device.

It is yet another object of the present invention to use the smart interactive device with a changeable display.

Accordingly, to achieve the above objects, there is provided a smart interactive billboard device for allowing billboards or other devices implemented with the smart billboard device, such as a stationary or mobile platform with a display screen, to display electronic/computer-based information and become interactive. The smart billboard device includes a transceiver adapted to communicate interactively with a server and at least one or more client devices to allow users to be interactive with the implemented billboards or other devices. Also provided is a CPU including software for controlling the implemented billboards or other devices, and a memory adapted to store information uploaded to the implemented billboards or other devices, or information received from the server and client devices. A display unit for displaying the information on the implemented, billboards or other devices can also included.

To further achieve the above objects, there is provided a smart interactive billboard system for allowing billboards or other devices implemented with a smart billboard device to display electronic/computer-based information and become interactive that includes a smart interactive billboard device and a server. The smart interactive billboard device includes a transceiver operative to communicate interactively with at least one user to allow the user to be interactive with the implemented billboards or other devices, a CPU including software operative to control the implemented billboards or other devices, and a memory adapted to store information received or uploaded to the implemented billboards or other devices. The server, which includes a server interface, is adapted to at least request information from and deliver information to the implemented billboards or other devices.

To further achieve the above objects, there is provided a smart interactive billboard system for allowing billboards or other devices implemented with a smart billboard device to display electronic/computer-based information and become interactive that includes a smart interactive billboard device and at least one client device. The smart interactive billboard device includes a transceiver operative to communicate interactively with at least one user to allow the user to be interactive with the implemented billboards or other devices, a CPU including software operative to control the implemented billboards or other devices, and a memory adapted to store information received or uploaded to the implemented billboards or other devices. The client device, which includes a client interface, is adapted to at least provide the user with the capability to upload information to or receive information from the smart interactive billboard device.

### BRIEF DESCRIPTION OF THE DRAWINGS

The above objectives and advantages of the present invention will become more apparent by describing in detail preferred embodiments thereof with reference to the attached drawings in which:

FIG. 1 shows an environment in which billboards are implemented with the smart interactive billboard device in accordance with the present invention;

FIG. 2 is a schematic diagram of the client device as shown in FIG. 1;

FIG. 3 is a schematic diagram of the server as shown in FIG. 1;

FIG. 4 is a schematic diagram of the billboard as shown in FIG. 1; and

FIG. 5 is an illustration of a real time embedded system that allows billboards or other devices to become interactive in accordance with the present invention.

### DESCRIPTION OF THE PREFERRED EMBODIMENTS

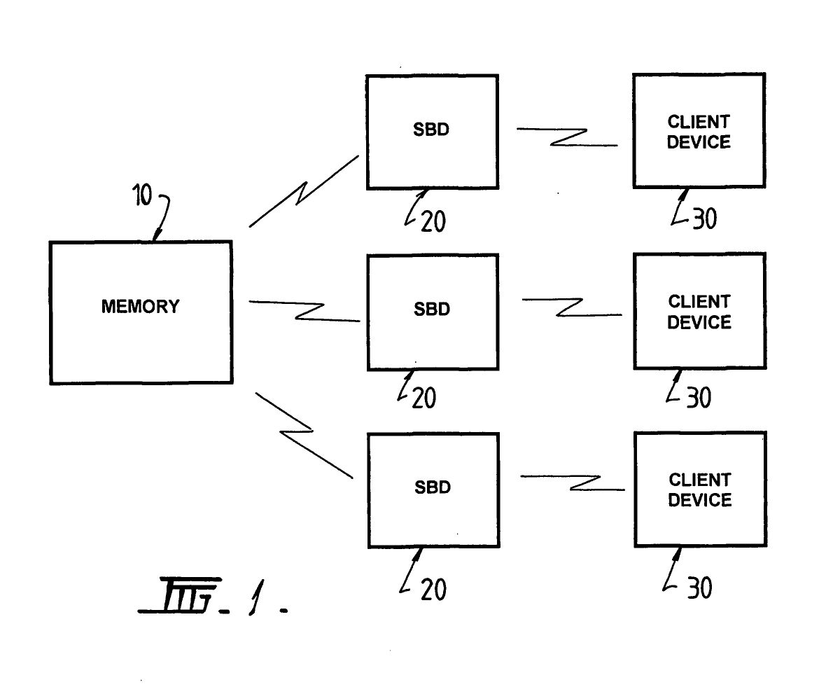

Referring to FIG. 1, shown is a system that embodies the present invention including a server 10, one or more interactive billboards 20, each implemented with the, smart interactive billboard device (SBD), and one or more client devices 30. The SBD can be installed on devices located at both stationary platforms such as buildings, roadsides, cinemas, other public places or the like, and mobile platforms such as vehicles. The stationary platforms and mobile platforms can be indoors or outdoors.

The server 10 has a server interface 13, including a>processor, and a database 15. The billboard 20, which is implemented with the SBD, includes a memory 22, an interface 24, including a processor, and a display screen 26. The display screen 26 may constitute the entire visible surface of the billboard may only constitute a part thereof, with the remainder being a static or predetermined display. The display screen 26 may comprise any number of changeable displays including a matrix of light bulbs, LEDs or the like, a flat panel display using organic or inorganic devices, or projection devices, as are known in the art. The client device 30 has a client interface 33, including a processor, and a memory 35. The server 10, the billboard 20 and the client device 30 communicate with each other via wireless, wired or infrared communications, or the like.

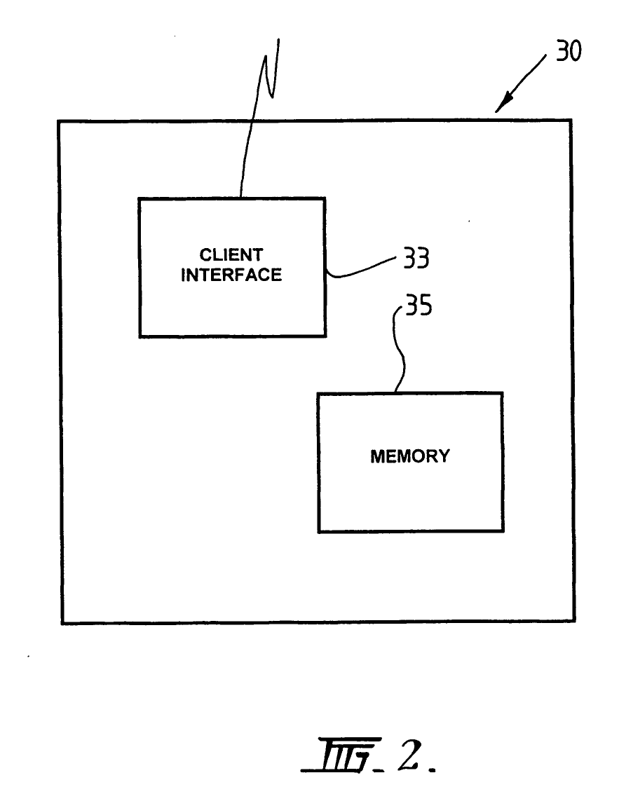

FIG. 2 provides a schematic diagram of the client device shown in FIG. 1. The client device 30 can be a personal computer, personal digital assistant (PDA), cellular or mobile phone, interactive television, radio system, or the like. The client interface 33 of the client device 30 allows the user or customer to interact via wireless, infrared and/or wired connections, or the like with the billboard 20. Wireless connections can include, for example, short messaging services (SMS) or a data service on an appropriate cellular technology such as GSM, Bluetooth (short range RF technology), infrared, IrDA or the like. The billboard 20 can be accessible by providing a hardwired or virtual button on the client device 30.

The user, via the client interface 33, can receive information from the billboard 20., upload information to the billboard 20, and download information to the client device 30 from the billboard 20. The user can also perform electronic commerce transactions using the information or advertisements (vAds) displayed on the display screen 26 of the billboard 20. The displayed information may include static or digital images and messages, sound, animation or the like. The user can save the downloaded information in the memory 35 of the client device 30 to be used at a later time. The user can also download portions of a vAd or a select quantity of information displayed on the display screen 26 of the billboard 20.

vAds can contain embedded information, such as the name of the advertised product, contact information of the advertising retailer, information links to the products/retailer, e-commerce information, customer service information, security features or the like. vAd is a compact wireless object exchange format developed by Kent Ridge Digital Labs of Singapore.

The user can also transfer or exchange information, vAds, promotional items, and compact certificates such as vCoupons, vVouchers, vTickets, vReceipts or the like, downloaded from the billboard 20 between other compatible client devices 30 vCoupons, vVouchers, vTickets and vReceipts are also compact wireless object exchange formats developed by Kent Ridge Digital Labs of Singapore.

The user via the client device 30 can also be targeted, as subsequently discussed, to receive specific information, vAds, compact certificates or the like from the billboard 20. Once the user receives the information, the user can save or store, browse, transfer, exchange or print the information. In addition, the user can perform electronic commerce using the received information.

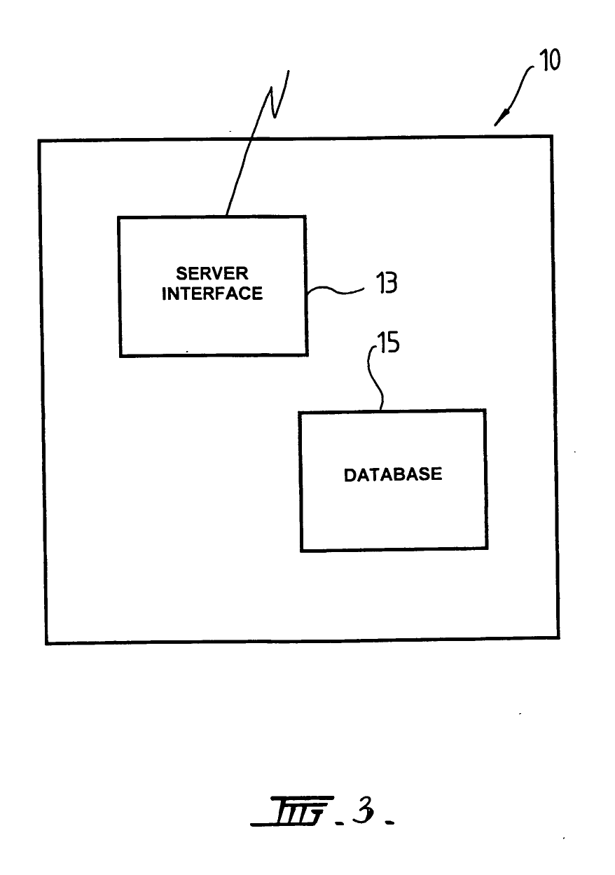

With reference to FIG. 3, the server 10 via server interface 13 communicates with the billboard 20 via a wireless, infrared and/or wired connections, or the like. Wireless connections can include, for example, SMS, digital video broadcast (DVB), digital audio broadcast (DAB), wireless modem, wireless dialup network or the like. The server interface 13 of the server 10 contains interface hardware and software that allows the server 10 to receive and transfer information, vAds, compact certificates or the like to the billboard 20. The information can be stored in the database 15 of the server 10 to be used at a later time.

The server 10 can transmit information to the billboard 20 to be displayed on the display screen 26. The information can be sent to a selected billboard 20 or to several billboards 20. The server 10 can also remotely update the information on the billboard 20. In other words, a new vAd would not be needed if the retailer wanted to update the vAd, thereby saving the retailer time and money. Further, the information can also be updated via a timing unit., as subsequently discussed.

Information or vAds can be formatted to include time or duration limitations and restrictions. For example, a vVoucher can be set to expire in 10 days, or a vAd can be set to change displayed store hours on different days. It is advantageous that the information or vAd be formatted using a uniform protocol so that the information can be delivered across multiple communication networks to various types of client devices 10.

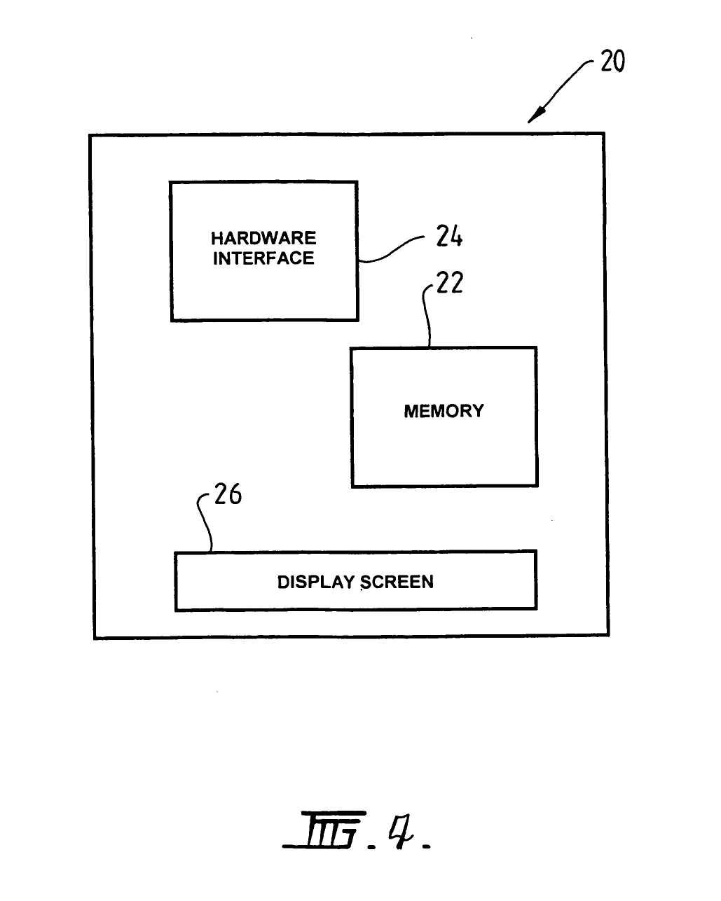

FIG. 4 is a schematic diagram of the client device billboard 20 shown in FIG. 1. The billboard 20, implemented with the SBD, includes at least a memory 22, an interface 24 and a display screen 26. The interface 24 of the billboard 20 can be an USB or UART interface.

The billboard 20 via interface 24 can receive and download information from the remote server 10. A network or a plurality of billboards 20 can be connected to a single server 10. The billboard 20 can communicate with the remote server 10 via SMS, DVB, DAB or the like. The server 10 provides information, vAds, compact certificates or the like to the billboard 20 to be displayed on the display screen 26 of the billboard 20, or delivered to client devices 30. The displayed images are of high quality., The billboard 20 via interface 24 can interact with a plurality of participating or registered users via their client devices 30. The billboard 20 via interface 24 can receive information from or send information to the client device 30. The information can be stored locally in the memory 22 to be used at a later time. The stored information can be forwarded to a client device 30 by a request made by the user's client device 30 or by broadcast applications.

When a user is passing by a billboard 20, the user, via client device 30, can download or upload information that is displayed on the display screen 26 of the billboard 20. Once the information is downloaded into the client device 20, the user, for example, can perform electronic commerce transactions. The user can purchase a product that is displayed on the display screen 26 using the information downloaded from the billboard 20.

In addition, the user can upload information, vAds, compact certificates such as vCoupons, vTickets, vVouchers, vReceipts or the like, to the billboard 20. Once the billboard 20 receives the information, it can be validated and redeemed. The uploaded information can also be transmitted, using the billboard 20, to a different client device 20. This allows users via their client devices 30 to exchange information amongst one another or participating users.

The billboard 20 via interface 24 can communicate with a Global Positioning System (GPS) or any other location finding facility remotely or directly in its hardware to provide location based information and services. For example, when a moving vehicle comprising the billboard 20 or other device, implemented with the SBD, travels a particular path or in a particular area, the billboard 20 displays on the display screen 26 information or different vAds relating to that path or area derived from the GPS.

The billboard 20 can also target users based on the user's client device 30, demographics, requirements and behavior. When a user connects to a particular webpage on his client device 30, call a particular telephone number on his client device 30, listen to a particular radio station on his client device 30, etc., information relating to the user can be transmitted to that user's client device 30. The same information can also be broadcast to a single client device 30 or a plurality of client devices 30.

The billboard 20 via interface 24 can communicate with a printing device for printing the compact certificates such as vCoupons, vVouchers, vTickets, vReceipts or the like, for validation and redeeming purposes.

The billboard 20 via interface 24 can connect to other devices such as a console, keypad, other accessories or the like. Once connected, the billboard 20 can remotely perform self-testing, reprogramming, information uploading, fault diagnostic examining and repairing. This is useful in order to maintain the appearance, functioning, maintenance or the like of the billboard 20. In addition, this eliminates the need for on-site repair or maintenance.

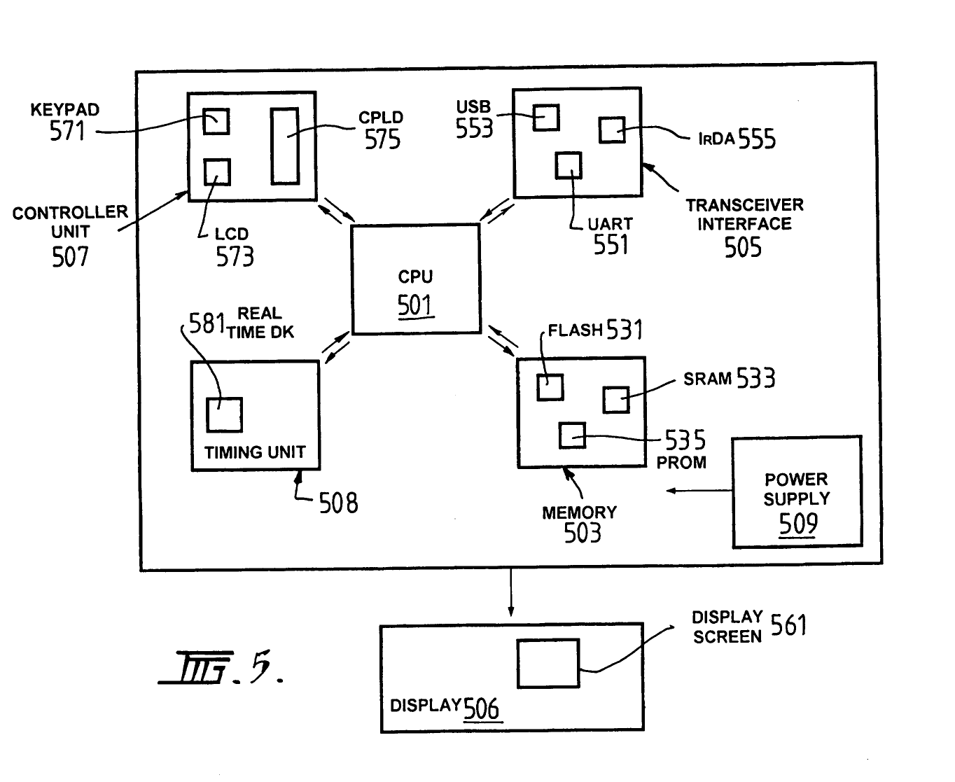

Existing or conventional billboards, even those without a changeable display can become interactive when implemented with applicable SBD hardware and software. The SBD can be easily connected to and installed on existing billboards so that they too become interactive. FIG. 5 is an illustration of a real time embedded system that allows billboards or other devices to become interactive. The system 50 includes, but not limited to, a CPU 501, external memory 503, transceiver 505, controller unit 507, timing unit 505 and power supply 509. The system 50 may or may not have a changeable display In a preferred embodiment, the CPU 501 including software, which controls the billboards and other devices, can be of the type Atmel AT91M40800, ARM7TDMI core, 32-bit RISC CPU, 32MIPS at 40 Mhz, TQFP100 Package, 2 USARTs, 32 PIOs (26 of which are multiplexed), 3 channel 16-bit Timer/Counters, Watchdog Timer, 1FIQ, 3 external IRQs, 64 Mbytes external addressing space, 8 Kbytes on-chip SRAM. The maximum addressing space of the CPU 501 external bus interface (EBI) is 64 Mbytes. The EBI can be configured for 4 external chip selection signals and A20-A23 are configured as PIOs, reducing the maximum available memory space to 4 Mbytes.

The memory 503 can include a flash 531 and SRAM 533. In the preferred embodiment, the flash 531 can be of the type 2 Mbytes in total size with 2 pieces of AT49LV080T(Atmel, 1 Mbytes, 3.3V), and the SRAM 533 can be of the type 2 Mbytes in total size with 4 pieces of HM628512BLFP (Hitachi, 512 Kbytes, 5V). A PROM 535, which can be of the type AT27C512R(Atmel), 64 Kbytes, 5V, PLCC32 Package, can also be used to debug and test the system 50.

The memory 503 stores uploaded information to or requested information from the billboards and other devices. In addition, the memory 503 stores information, commands, updates, changes or the like to be used by the billboards and other devices at a later time.

The transceiver 505 can be a RS232 (UART) 551, USB 553 or IRDA 555. The RS232 551 can be of the type MAX3224E(Maxim), 2Rx, 2Tx, 3.3V, 15 KV ESD protection, low power consumption, SO20 Package. The USB 553 can be of the type ISP1107 (Philips), fully compliant with USB Spec Rev. 1.1, supporting both 12 Mbit/s and 1.5 Mbit/s, 4 kV ESD protection, TSSOP16 Package. The IrDA 555 can be of the type IRMS6400 (Infineon).

The transceiver 505 allows billboards or other devices to communicate interactively with servers 10 and various types of client devices 30. With such, the billboards or other devices can receive information from the server 10, and users can receive information upon request via their client devices 20 or by broadcast applications. In addition, the transceiver 505 can communicate with various components such as a printer, GPS, console unit or the like. When interfaced with a printer, vAds and compact certificates, i.e., vCoupons, vVouchers, vTickets, vReceipts or the like, can be printed. Likewise, when interfaced with a GPS, as discussed above, information relating to demographics can be provided to the billboard or other devices.

The display 506 can be a self-contained unit that includes a substantially flat screen display 561 or other type of panel or projection display, as known in the art. The display 506 can be connected to the CPU 501 to provide and/or request (transmit and/or receive) information to be displayed on the screen display 561 of the display 506. Once the information is received by the transceiver 505 or via the server 10, the information is processed by the CPU 501 and forwarded or directed to the display screen 561 of the display 506. Further, the received information can be stored in the memory 503 to be used at a later time.

The controller unit 507 can include a keypad 571, LCD 573 and CPU 575. In the preferred embodiment, the keypad 571 can be of the type 16 key membrane (Bopla), the LCD 573 can be of the type MDLS16465-LV-LED04 (Varitronix), 16×4 with backlight, 5V, screen size 61.8×25.2, and the CPLD 575 can be of the type XC9572PQ100 (Xilinx), 72 MicroCells, 5V.

The CPLD 575 can be used for keypad 571 dynamic scanning and LCD 573 control. A serial data communication protocol can be designed between the CPU 501 and the CPLD 575. When a valid key pressed on the keypad 571 is detected and captured, the CPLD 575 can decode the key position and send the key scan code to the CPU 501. When a display command is received from the CPU 501, the CPLD 575 can decode the command and send it to the display module 573 in the correct format.

Further, the controller unit 507 allows the billboards or other devices to perform self-testing, reprogramming, information uploading, fault diagnostic examining and repairing.

The timing unit 508 can include a real time clock 581. In the preferred embodiment, the real time clock 581 can be of the type DS1302Z (Dallas), real time clock/calendar with leap year compensation valid up to year 2100, 0.3 μA at 2V, SOIC8(150 mil) package.

The timing unit 508 can control, i.e., update, delete or change, the information that is displayed on the screen display 561 of the display 506. Displayed information can be automatically updated, deleted or changed based on the settings of the real time clock 581 of the timing unit 508. For example, the timing unit 508 can determine when the information is to be displayed and in what sequence the information is to be displayed. Changes, deletions and updates to the information may include changes to the content of information to be displayed and times that the information is displayed on the display 506.

In the preferred embodiment, the power supply 509′, which supplies power, can be 5V or 3.3V. The 5V power supply 509 can be of the type MAX738A(Maxim), 450 mA, switching current mode, step down, DC-DC converter, input range 6˜16V, and the 3.3V power supply 509 can be of the type MAX748A(Maxim), 450 mA, switching current mode, step down, DC-DC converter, input range 3.3˜16V.

Once the system 50 is provided with, connected to or installed on a billboard, the billboard becomes interactive. The billboard will be communicable with the server 10 and client devices 30. As described above, the implemented billboards or other devices can display electronic/computer-based information and become interactive. In addition, users via client devices 30 can remotely upload information to, download information from, and perform electronic commerce transactions with the billboards.

Having described the invention in detail and by reference to the drawings, it will be apparent that modification and variations are possible without departing from the scope of the invention. Therefore, it is intended that the invention not be limited by the precise structure illustrated and described, but rather the full scope of the invention as defined in the following claims.

1. A smart interactive billboard device, operable with stationary or mobile advertising platforms that display information to provide electronic/computer-based advertising, promotional and/or sales information, comprising:
a transceiver operative to communicate with at least one client device by at least transmitting advertising, promotional and/or sales information;
a CPU including software operative to control the transceiver and provide communication with the client device; and
a memory adapted to store advertising, promotional and/or sales information for transmission by the transceiver to said at least one client device.

2. The smart interactive billboard device according to claim 1, further comprising a controller adapted to allow the billboard device to perform at least one of self-testing, reprogramming, information uploading, fault diagnostic examining or repairing.

3. The smart interactive billboard device according to claim 2, wherein the controller includes at least an operator input and an operator display.

4. The smart interactive billboard device according to claim 1, wherein said transceiver is operative to communicate interactively with at least one client device by further receiving advertising, promotional and/or sales information;
said CPU including software operative to control the transceiver and provide interactive communication with the client device; and
said memory further adapted to store advertising promotional and/or sales information received by the transceiver from said at least one client device.

5. The smart interactive billboard device according to claim 1, wherein the memory includes at least one of a flash memory, PROM or SRAM.

6. The smart interactive billboard device according to claim 1, further comprising an interface that is at least one of USB or UART.

7. The smart interactive billboard device according to claim 1, comprising means operable to enable a user via a client device to interactively download information from or upload information to the billboard device.

8. The smart interactive billboard device according to claim 1, comprising means operable to enable a user via the client device to perform electronic commerce transactions with respect to the information provided to the billboard device.

9. The smart interactive billboard device according to claim 1, comprising means operable to enable a user via the client device to exchange or transfer information amongst other users using the billboard device.

10. The smart interactive billboard device according to claim 1, wherein the information displayed on the stationary or mobile platform are advertisements.

11. The smart interactive billboard device according to claim 7, wherein the information uploaded to or download from the billboard device is at least one of electronic vouchers, electronic coupons, electronic tickets, electronic receipts, or electronic advertisements.

12. The smart interactive billboard device according to claim 1, wherein the smart interactive billboard device is adapted to be located and installed on stationary or mobile platforms.

13. The smart interactive billboard device according to claim 1, wherein the billboard device further comprises means for communicating interactively with a server through at least one of SMS, DVB, DAB, wireless modem or wireless dialup network.

14. The smart interactive billboard device according to claim 1, wherein the transceiver is adapted to communicate interactively with the client device through at least one of SMS, Bluetooth, infrared or IrDA.

15. A smart interactive billboard system, operable with stationary or mobile advertising platforms that display information to provide electronic/computer-based advertising, promotional and/or sales information, comprising:
an advertising platform;
a smart interactive billboard device mounted to said advertising platform and including:
a transceiver operative to communicate interactively with at least one client device by at least transmitting advertising, promotional and/or sales information;
a CPU including software operative to control the transceiver and enable interactive communication with the at least one client device; and
a memory adapted to store information for transmission by or received by the transceiver, and
a display unit, including a display screen, responsive to the smart interactive billboard device and operative to display on said screen advertising, promotional and/or sales information under control of said CPU.

16. The smart interactive billboard device according to claim 15, wherein the CPU is operative to update and change the displayed advertising, promotional and/or sales information.

17. The smart interactive billboard device according to claim 15, wherein the billboard device further comprises means for communicating interactively with a server through at least one of SMS, DVB, DAB, wireless modem or wireless dialup network.

18. The smart interactive billboard device according to claim 15, wherein the transceiver is adapted to communicate interactively with the client device through at least one of SMS, Bluetooth, infrared or IrDA.

19. The smart interactive billboard device according to claim 1S, wherein said transceiver is operative to communicate interactively with at least one client device by further receiving advertising, promotional and/or sales information;
said CPU including software operative to control the transceiver and provide interactive communication with the client device; and
said memory further adapted to store advertising, promotional and/or sales information received by the transceiver from said at least one client device.

20. A smart interactive billboard system for providing interactive communication with at least one client device comprising:
a server;
a plurality of advertising platforms;
a smart interactive billboard device mounted to each said advertising platform and including:
a transceiver means operative to communicate interactively with the client device and the server by at least one of transmitting and receiving information,
a CPU including software operative to control the transceiver and the interactive communication with the server, and
a memory adapted to store information for transmission by or received by the transceiver; and
wherein the server is in communication with said plurality of smart interactive billboard devices and wherein said server includes a communication interface operative to at least request information from and deliver information to the plurality of interactive billboard devices.

21. The smart interactive billboard system according to claim 20, wherein at least one smart interactive billboard device is mounted to an advertising platform, wherein the platform further comprising a display unit operative to display advertising, promotional and/or sales information provided by the server.

22. The smart interactive billboard system according to claim 20, wherein the server is adapted to selectively transmit information to one or more interactive billboard devices.

23. The smart interactive billboard system according to claim 20, wherein the server and the smart interactive billboard devices are communicable through at least one of SMS, DVB, DAB, Wireless modem or wireless dialup network.

24. A smart interactive billboard system operative to enable interactive communication with a mobile user, comprising:
an advertising platform;
a smart interactive billboard device mounted to the advertising platform and including:
a transceiver operative to communicate interactively with at least one user-operated client device by at least one of transmitting and receiving information,
a CPU including software operative to control the transceiver and the interactive communication with the client device, and
a memory adapted to store information for transmission by or received by the transceiver; and
the at least one user-operated client device, including a client transceiver, operative to at least provide the user with the capability of at least one of uploading information to or receiving information from the smart interactive billboard device.

25. The smart interactive billboard system according to claim 24, wherein the advertising platform further comprises a display unit, including a display screen responsive to the smart interactive billboard device and operative to display information provided by the device.

26. The smart interactive billboard system according to claim 25, wherein the advertising platform is one of a stationary or a mobile platform.

27. The smart interactive billboard system according to claim 24, wherein the client device is at least-one of a personal computer, personal digital assistant, cellular or mobile phone, interactive television or radio system.

28. The smart interactive billboard system according to claim 24, wherein the client device is adapted to allow the user to perform electronic commerce transactions with respect to the information provided to the billboard device.

29. The smart interactive billboard system according to claim 24, wherein the client device is adapted to allow the user to exchange or transfer information amongst other users with client devices via the advertising platform.

30. The smart interactive billboard system according to claim 24, wherein the client device is a remote wired device.

31. The smart interactive billboard system according to claim 24, wherein the client device is a remote wireless device.

32. The smart interactive billboard system according to claim 24, wherein the client device and the smart interactive billboard device are responsive to at least one of SMS, Bluetooth, infrared or IrDA.

33. The smart interactive billboard system according to claim 25, wherein the advertising platform is a mobile platform and wherein the smart interactive billboard device includes a GSM receiver for receiving GSM signals containing GSM information; and
the CPU is responsive to the received GSM signals and changes the display according to the GSM information.
